(19) United States
(12) Patent Application Publication
(10) Pub. No.: US 2012/0183932 A1
(43) Pub. Date: Jul. 19, 2012

(54) Location-Aware Nutrition Management

(75) Inventors: Hung-Yang Chang, Scarsdale, NY (US); Mark Hsiao, Sindian City (TW); Pei-Yun S. Hsueh, White Plains, NY (US); Leslie S. Liu, White Plains, NY (US); Liangzhao Zeng, Mohegan Lake, NY (US)

(73) Assignee: INTERNATIONAL BUSINESS MACHINES CORPORATION, Armonk, NY (US)

(21) Appl. No.: 13/007,186

(22) Filed: Jan. 14, 2011

(51) Int. Cl. G09B 19/00

(52) U.S. Cl. 434/127

(57) ABSTRACT

Techniques for providing personalized location-aware nutrition management information are provided. The techniques include receiving geographical coordinates of an individual, acquiring nutritional information from one or more food providers within a designated proximity of the geographical coordinates of the individual, generating one or more nutrition selection options for the individual based on the nutritional information from the one or more food providers within a designated proximity of the geographical coordinates of the individual and dynamic nutritional guidelines for the individual, and outputting the one or more nutrition selection options to the individual.

### FIELD OF THE INVENTION

Embodiments of the invention generally relate to information technology, and, more particularly, to health management.

### BACKGROUND OF THE INVENTION

Existing health and nutrition management approaches focus on developing a system that can help store a user's intake or query nutrition facts of a food in a manual fashion. However, such approaches are time-consuming, and it may be difficult for a user to find the appropriate food from a multitude of food categories, and users may need to specify their food preferences tediously and manually during an enrollment process. Additionally, many existing approaches merely provide information for meals stored in a database with no customizable features.

### SUMMARY OF THE INVENTION

Principles and embodiments of the invention provide techniques for location-aware nutrition management. An exemplary method (which may be computer-implemented) for providing personalized location-aware nutrition management information, according to one aspect of the invention, can include steps of receiving geographical coordinates of an individual, acquiring nutritional information from one or more food providers within a designated proximity of the geographical coordinates of the individual, generating one or more nutrition selection options for the individual based on the nutritional information from the one or more food providers within a designated proximity of the geographical coordinates of the individual and dynamic nutritional guidelines for the individual, and outputting the one or more nutrition selection options to the individual.

One or more embodiments of the invention or elements thereof can be implemented in the form of a computer product including a tangible computer readable storage medium with computer useable program code for performing the method steps indicated. Furthermore, one or more embodiments of the invention or elements thereof can be implemented in the form of an apparatus including a memory and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s), or (iii) a combination of hardware and software modules; any of (i)-(iii) implement the specific techniques set forth herein, and the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating example architecture, according to an embodiment of the invention;

FIG. 2 is a flow diagram illustrating techniques for providing personalized location-aware nutrition management information, according to an embodiment of the invention; and

FIG. 3 is a system diagram of an exemplary computer system on which at least one embodiment of the invention can be implemented.

### DETAILED DESCRIPTION OF EMBODIMENTS

Principles of the invention include techniques for in-take and location-aware food recommendations for individuals. One or more embodiments of the invention provide a system for location-aware diet management and recommendations on portable electronic devices, which provide a user healthy meal planning according to a user's location and additional parameters (such as, for example, healthy daily nutrition requirements). The techniques described herein can also include providing notification to a user for potential glucose excursions based on his or her current intake and historical wellness records.

Additionally, one or more embodiments of the invention include providing features such as, for example, a smart input, a location-aware personal diet planner, and a personal predictive model.

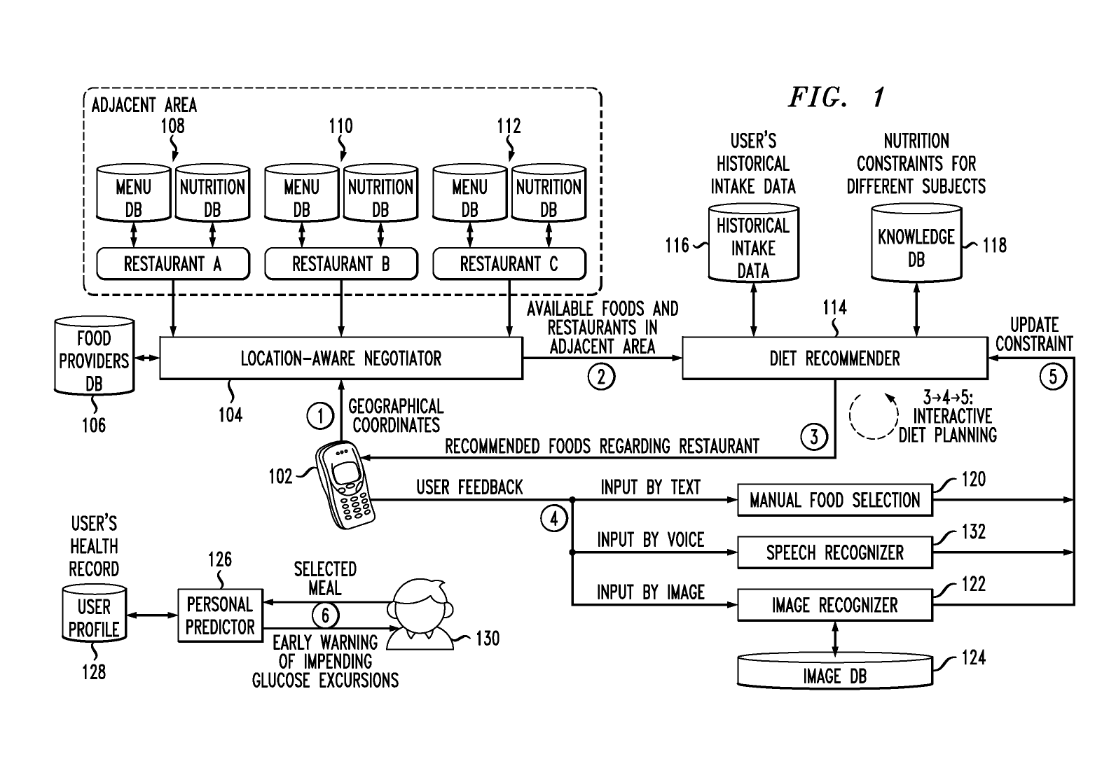

FIG. 1 is a diagram illustrating example architecture, according to an embodiment of the invention. As described herein, one or more embodiments of the invention include four primary components/modules: a location-aware negotiator module 104, a diet recommender module 114, an image recognizer module 122, a speech recognizer module 132 and a personal predictor module 126. Additionally, in the depicted example embodiment illustrated in FIG. 1, six primary steps are detailed.

In steps 1 and 2, the location-aware negotiator module 104 receives geographical coordinates from a user's mobile device 102 (for example, via global positioning system (GPS) capability) and negotiates with food providers adjacent to user's current location (for example, restaurants (with corresponding menu and nutrition databases) 108, 110 and 112) for acquiring meals and corresponding nutrition facts. By way of example, in one or more embodiments of the invention, restaurants/food providers sign-up certain services to join the system implemented by one embodiments of the invention. For instance, in a central database scenario, the location-aware negotiator can maintain a food provider database (DB) as well as a replica DB containing all foods and/or nutrition facts from all involved restaurants/food providers. In such a scenario, a back-end server can provide, for example, a restful-based web service for synchronizing the data between the system of one or more embodiments of the invention and that of the partners. In another instance, for example, in the case of a distributed database scenario wherein restaurants/food providers maintain their own food/nutrition DB, partners can implement a pre-defined web service interface so that one or more embodiments of the invention can exchange information therewith.

As also depicted in FIG. 1, a food DB 106 provides the location information of restaurants or food providers to the location-aware negotiator module 104, and the collected information is delivered to the diet recommender module 114 in step 2.

In step 3, the diet recommender module 114 solves the multi-objective diet selection problem according to a knowledge DB 118, which stores nutrition constraints for different subjects (for example, healthy individuals, diabetic patients, etc.), and a historical intake data component 116, which records a user's historical diet preferences. Mathematically, the diet planning can be formulated, in one or more embodiments of the invention, as a multi-objective optimization problem, where the fundamental objectives are to find a food combination that (1) comes as close as possible to the expected daily nutrition requirements recommended by Dietary Reference Intakes (DRI), and (2) satisfies an individual's preference regarding different kinds of foods. Constraints can be introduced to ensure that designated diets meet various personal expectations. Examples can include:
Location (food provider or restaurant) constraint: The availability of foods within proximity of a user's current location.
Budget constraint: If a user has budget concerns and prefers low-priced food, the budget constraint can place an upper limit on total meal price.
Diversity constraint: A meal can include a diverse set of foods from different food categories (for example, appetizer, salad, main dish, dessert and snack) rather than wholly from a single category.
Quantity constraint: If a user wants to have a specific food (or food amount) in his/her meal, then the quantity constraint can make sure the result meets the user's expectation.

Once step 3 (as depicted in FIG. 1) is complete, a combination of available dishes and restaurants that satisfy the nutritional requirements (for example, the daily nutritional requirements) and user's current locality will be sent to the user (for example, to the user's mobile device).

In step 4, users can also interact with the system to adjust the recommended meal plan for meeting personal preferences. In addition to the traditional manual selection (for example, input by text) via a graphical interface (that is, a manual food selection module 120 as depicted in FIG. 1), an image recognizer module 122 supports an advanced image query scheme (that is, inputting the preferred dish or food item by directly taking a photograph of the item on a mobile device or scanning a one-dimensional (1D)/two-dimensional (2D)-barcode of the item via a mobile device) to alleviate the food search effort. In such a scenario, a salient image feature will be extracted and compared with an image DB 124 to identify the desired item. Additionally, a user can provide input by voice (via a mobile device 102) for food query and/or selection. Voice input can be processed by the speech recognizer module 132 and used, for example, to update constraints.

In step 5, one or more embodiments of the invention can include updating the constraints (for example, the number of pasta must be at least 1) via the diet recommender module 114 and knowledge DB 118 to give a customized diet plan according to a user's selection. As depicted in FIG. 1, steps 3, 4 and 5 detail interactive diet planning. One or more embodiments of the invention provide a user an initial meal suggestion based on the result of the multi-objective optimization, where all predefined constraints were met. After examining the initial suggestion, the user may still want to experiment with a “what if” analysis (for example, replace A food with B food) and find an even better food combination for himself/herself. For example, the user might like to have a chocolate after his/her main course. In this case, the user can, for example, take a picture of the chocolate on the menu to add this item, and one or more embodiments of the invention will automatically find another well-converged and well-distributed Pareto-optimal front based on the updated constraints (that is, the quantity of chocolate needs to be at least one). Further, to achieve a more customizable diet plan that can capture a user's favor, a user can iterate from step 3 to step 5 until he or she establishes an acceptable diet combination.

In step 6, once the user has decided upon a meal or food item, the personal predictor module 126 predicts (and sends to the user 130) a future trend of the user's glucose (or other nutritional aspect) based on the current food intake and the temporal pattern of the user's historical records (derived, for example, from a user profile module 128). As noted, not only glucose, but also anything related to personal physical health and fitness can be analyzed to foresee a future trend, and all prediction results can be collected and provided to either the user (for example, via an alert) or the diet recommender (for example, via an updated constraint). By way merely of example, if the system foresees a significantly increased serum uric acid level of a user in the near future, one or more embodiments of the invention can suggest avoiding (or proactively adjusting) high purine foods (for example, seafood) even if the designated meal meets all pre-defined nutrition goals and constraints.

As such, in one or more embodiments of the invention, a pre-trained model (for example, an autoregressive model) can be employed for trend glucose prediction task. By way of example, one or more embodiments of the invention can include using time-series glucose signals and data-driven models (for example, an autoregressive (AR) model) to predict near-future glucose concentrations from past signals, and leveraging this predictive capability to anticipate possible glucose excursions and adjust the diet planning result before concentrations drift from the desired range. As such, an AR(p) model can be defined as Xₜ=c+Σψᵢ Xₜ₋ᵢ+εₜ, where X is the signal (for example, glucose level), are the parameters of the model, c is a constant and εₜ is white noise. The parameters can be estimated via various methods using the past signals as training data, and the learned model can then be used to predict the next n-step X value. In this case, if the system foresees a glucose excursion in the next n-step based on the pre-trained model, then the suggested food combination should avoid foods with a high glycemic index (GI). Additionally, as noted herein, one or more embodiments of the invention can include signaling a warning message to the user if there are any impending complications (for example, any impending glucose excursions).

As described herein, one or more embodiments of the invention include various smarter input techniques such as, for example, the ability to capture a food image and GPS data from a mobile device as input for food intake. By way of example, GPS information can indicate a restaurant name, which can aid the system in recognizing the food using the images (via a pre-established database of content, for example). Additionally, one or more embodiments of the invention include providing a location-aware food recommendation, which automatically presents the user with a combination of dishes and restaurants that satisfy the user's current (or otherwise chosen) locality) as well as parameters such as, for example, daily nutritional requirements. Also, interactive diet planning via the inputs detailed here can provide users a more customized food recommendation pertaining to their preferences and/or requirements.

Further, one or more embodiments of the invention include employing a personal predictive model to predict potential health and/or nutrition ramifications (such as, for example, impending glucose excursions (for individuals with diabetes, for instance)). The prediction model provides opportunity for proactive intervention and adjustment of nutritional planning (for example, proactive adjustment of therapy before glucose concentrations drift from desired ranges).

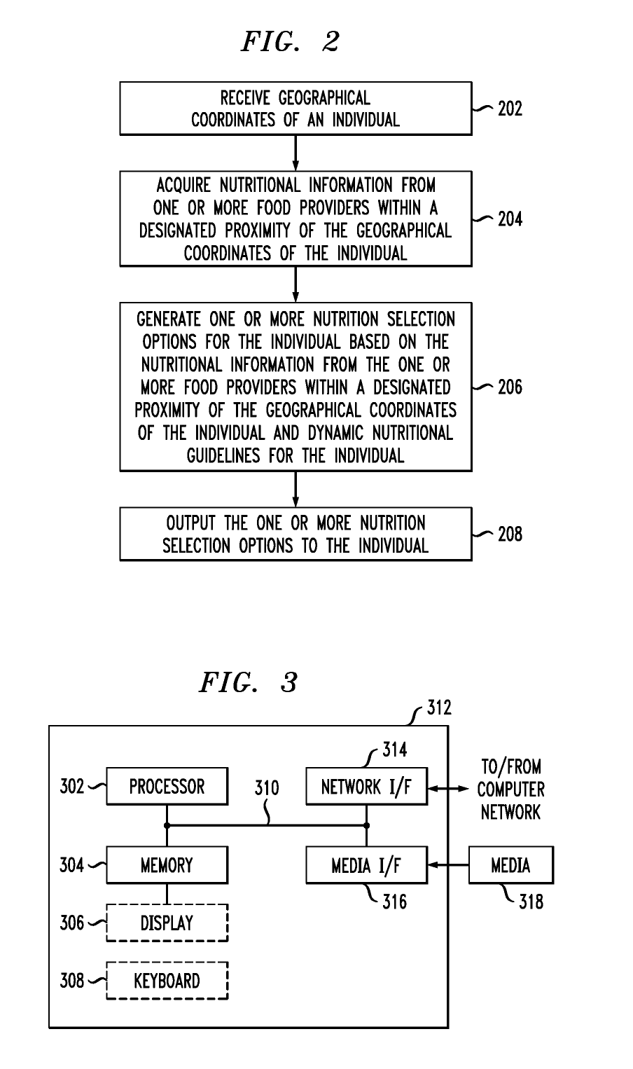

FIG. 2 is a flow diagram illustrating techniques for providing personalized location-aware nutrition management information, according to an embodiment of the present invention. Step 202 includes receiving geographical coordinates of an individual. This step can be carried out, for example, using a location-aware negotiator module. Receiving geographical coordinates of an individual can include, for example, receiving geographical coordinates from a mobile device (for example, via global positioning system capability, a scan of QR code, or near field communication).

Step 204 includes acquiring nutritional information from one or more food providers (for example, restaurants) within a designated proximity of the geographical coordinates of the individual. This step can be carried out, for example, using a location-aware negotiator module. Acquiring nutritional information from food providers can include, for example, accessing information from a menu database, a nutrition database of one or more food providers, a database collected via one or more healthcare professionals, and a database collected via one or more interne communities (for example, people who tag a restaurant on an online program, paid annotators, etc.) and/or a database collected via one or more nutrition associations (for example, a set of dietitians that collectively verify nutrition facts and add recommendations of restaurant and menu items, diabetes association members who add tags to a database and provide up-to-date modifications to a database, etc.), acquiring information pertaining to one or more meals and corresponding nutrition facts, and/or acquiring location information food providers from a food provider database.

Step 206 includes generating one or more nutrition selection options for the individual based on the nutritional information from the one or more food providers within a designated proximity of the geographical coordinates of the individual and dynamic nutritional guidelines for the individual. This step can be carried out, for example, using a diet recommender module. Nutritional guidelines for the individual can include, for example, one or more nutrition constraints, and/or historical intake data for the individual. Also, the nutrition selection options can include, for example, a combination of available food items (that is, food and/or beverages) and food providers that satisfy nutritional requirements and current locality of the individual.

Step 208 includes outputting the one or more nutrition selection options to the individual. This step can be carried out, for example, using a diet recommender module. Outputting the nutrition selection options to the individual can include, for example, outputting the nutrition selection options to a mobile device.

The techniques depicted in FIG. 2 also include enabling receipt of nutritional information from an individual. This can include, for example, manual selection of a food item via text input from the individual via a graphical interface, an input of a food item via an image captured by a mobile device, a camera, a barcode scanner and/or an optical character recognition scanner (for example, a photograph of the food item taken on a mobile device), input from a voice input from a user and/or an input from a short-range high-frequency wireless communication protocol (for example, a barcode of a food item scanned via a mobile device, near filed communication via a mobile device and radio-frequency identification via a mobile device).

One or more embodiments of the invention can also include updating nutrition constraints of an individual, wherein updating the one or more nutrition constraints of an individual comprises incorporating feedback from at least one of the individual and a diet recommender component. Further, the techniques depicted in FIG. 2 include generating a future trend prediction for one or more nutritional parameters for the individual based on the nutrition selection options and nutritional information pertaining to the individual. This can additionally include outputting a warning message to the individual if a future trend prediction signals an impending nutritional complication.

The techniques depicted in FIG. 2 can also, as described herein, include providing a system, wherein the system includes distinct software modules, each of the distinct software modules being embodied on a tangible computer-readable recordable storage medium. All the modules (or any subset thereof) can be on the same medium, or each can be on a different medium, for example. The modules can include any or all of the components shown in the figures. In one or more embodiments, the modules include a location-aware negotiator module, a diet recommender module, an image recognizer module, and a personal predictor module that can run, for example on one or more hardware processors. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in one or more embodiments of the invention, the computer program product can include computer useable program code that is stored in a computer readable storage medium in a server data processing system, and wherein the computer useable program code are downloaded over a network to a remote data processing system for use in a computer readable storage medium with the remote system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, can be implemented in the form of an apparatus including a memory and at least one processor that is coupled to the memory and operative to perform exemplary method steps.

One or more embodiments can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As noted, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Media block 318 is a non-limiting example. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, component, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the components shown in FIG. 1. The method steps can then be carried out using the distinct software modules and/or sub-modules of the system, as described above, executing on one or more hardware processors 302. Further, a computer program product can include a computer-readable storage medium with code adapted to be implemented to carry out one or more method steps described herein, including the provision of the system with the distinct software modules.

In any case, it should be understood that the components illustrated herein may be implemented in various forms of hardware, software, or combinations thereof; for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the to invention. The embodiment was chosen and described in order to best explain the principles of the invention and the practical application, and to enable others of ordinary skill in the art to understand the invention for various embodiments with various modifications as are suited to the particular use contemplated.

At least one embodiment of the invention may provide one or more beneficial effects, such as, for example, providing healthy meal planning according to a user's location and daily nutrition requirements.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art.

What is claimed is:

1. A method for providing personalized location-aware nutrition management information, wherein the method comprises:
receiving geographical coordinates of an individual;
acquiring nutritional information from one or more food providers within a designated proximity of the geographical coordinates of the individual;
generating one or more nutrition selection options for the individual based on the nutritional information from the one or more food providers within a designated proximity of the geographical coordinates of the individual and dynamic nutritional guidelines for the individual; and
outputting the one or more nutrition selection options to the individual.

2. The method of claim 1, wherein dynamic nutritional guidelines for the individual comprises one or more nutrition constraints.

3. The method of claim 2, further comprising updating the one or more nutrition constraints of an individual, wherein updating the one or more nutrition constraints of an individual comprises incorporating feedback from at least one of the individual and a diet recommender component.

4. The method of claim 1, wherein dynamic nutritional guidelines for the individual comprises historical intake data for the individual.

5. The method of claim 1, further comprising enabling receipt of nutritional information from an individual.

6. The method of claim 5, wherein nutritional information from an individual comprises manual selection of a food item via text input from the individual via a graphical interface.

7. The method of claim 5, wherein nutritional information from an individual comprises an input of a food item via an image captured by at least one of a mobile device, a camera, a barcode scanner and an optical character recognition scanner.

8. The method of claim 5, wherein nutritional information from an individual comprises at least one of a voice input from a user and an input from a short-range high-frequency wireless communication protocol.

9. The method of claim 1, further comprising generating a future trend prediction for one or more nutritional parameters for the individual based on the one or more nutrition selection options and nutritional information pertaining to the individual.

10. The method of claim 9, further comprising outputting a warning message to the individual if a future trend prediction for one or more nutritional parameters signals an impending nutritional complication.

11. The method of claim 1, wherein receiving geographical coordinates of an individual comprises receiving geographical coordinates from a mobile device.

12. The method of claim 1, wherein the one or more food providers comprise one or more restaurants.

13. The method of claim 1, wherein acquiring nutritional information from one or more food providers comprises accessing information from at least one of a menu database, a nutrition database of one or more food providers, a database collected via one or more healthcare professionals, and a database collected via one or more internet communities.

14. The method of claim 1, wherein acquiring nutritional information from one or more food providers comprises acquiring information pertaining to one or more meals and corresponding nutrition facts.

15. The method of claim 1, wherein acquiring nutritional information from one or more food providers comprises acquiring location information of one or more food providers from a food provider database.

16. The method of claim 1, wherein the one or more nutrition selection options comprise a combination of available food items and food providers that satisfy one or more nutritional requirements and current locality of the individual.

17. The method of claim 1, wherein outputting the one or more nutrition selection options to the individual comprises outputting the one or more nutrition selection options to a mobile device.

18. The method of claim 1, further comprising providing a system, wherein the system comprises one or more distinct software modules, each of the one or more distinct software modules being embodied on a tangible computer-readable recordable storage medium, and wherein the one or more distinct software modules comprise a location-aware negotiator module and a diet recommender module executing on a hardware processor.

19. A computer program product comprising a tangible computer readable recordable storage medium including computer useable program code for providing personalized location-aware nutrition management information, the computer program product including:
computer useable program code for receiving geographical coordinates of an individual;
computer useable program code for acquiring nutritional information from one or more food providers within a designated proximity of the geographical coordinates of the individual;
computer useable program code for generating one or more nutrition selection options for the individual based on the nutritional information from the one or more food providers within a designated proximity of the geographical coordinates of the individual and dynamic nutritional guidelines for the individual; and
computer useable program code for outputting the one or more nutrition selection options to the individual.

20. The computer program product of claim 19, wherein dynamic nutritional guidelines for the individual comprises one or more nutrition constraints.

21. The computer program product of claim 20, further comprising computer useable program code for updating the one or more nutrition constraints of an individual, wherein updating the one or more nutrition constraints of an individual comprises incorporating feedback from at least one of the individual and a diet recommender component.

22. A system for providing personalized location-aware nutrition management information, comprising:
a memory; and
at least one processor coupled to the memory and operative to:
receive geographical coordinates of an individual;
acquire nutritional information from one or more food providers within a designated proximity of the geographical coordinates of the individual;
generate one or more nutrition selection options for the individual based on the nutritional information from the one or more food providers within a designated proximity of the geographical coordinates of the individual and dynamic nutritional guidelines for the individual; and
output the one or more nutrition selection options to the individual.

23. The system of claim 22, wherein dynamic nutritional guidelines for the individual comprises one or more nutrition constraints.

24. The system of claim 23, wherein the at least one processor coupled to the memory is further operative to update the one or more nutrition constraints of an individual, wherein updating the one or more nutrition constraints of an individual comprises incorporating feedback from at least one of the individual and a diet recommender component.

25. An apparatus for providing personalized location-aware nutrition management information, the apparatus comprising:
means for receiving geographical coordinates of an individual;
means for acquiring nutritional information from one or more food providers within a designated proximity of the geographical coordinates of the individual;
means for generating one or more nutrition selection options for the individual based on the nutritional information from the one or more food providers within a designated proximity of the geographical coordinates of the individual and dynamic nutritional guidelines for the individual; and
means for outputting the one or more nutrition selection options to the individual.
